(19) United States
(12) Patent Application Publication
(10) Pub. No.: US 2003/0051381 A1
(43) Pub. Date: Mar. 20, 2003

(54) Poster board with handles

(76) Inventors: Henry Hernandez, Spring, TX (US); John A. Brocato, Katy, TX (US)

Correspondence Address: Kurt J. Brown, Suite 200, 1535 West Loop South, Houston, TX, 77027, US

(21) Appl. No.: 09/954,238

(22) Filed: Sep. 17, 2001

(51) Int. Cl. G09F 1/00; G09F 21/02

(52) U.S. Cl. 40/586; 40/124.09

(57) ABSTRACT

A series of embodiments of the poster board invention (“Smartboard™”) are described, using various types of securing handles, to aid in grasping and maintaining positioning of the board.

Additional features of some of the embodiments of the poster board system with handles, include the ability to crease, fold, or collapse the board, such as into an accordion form; to have pre-printed permanent or erasable lines; to have pop-outs or cut-outs for visibility; to have pre-printed graphics or messages; to have fittings for attaching attention-getting devices such as flags, lights, sound-making devices, or banners; and to have fittings for extending the board size or for connecting multiple boards together.

The securing handles may be permanently and fixedly attached, or detachable. Among embodiments of the handles are securing means including adhesive foam, staples, and locking tab systems.

Another embodiment of the poster board system with handles is as a greeting card holder, in which securing devices are positioned between the creases of the accordion-folded poster board system. In this embodiment, the poster board system with handles, holds a plurality of greeting cards. Another embodiment of the poster board system with handles which holds greeting cards, includes a plastic sheet protector as the securing device.

A further embodiment of the poster board system with handles is as a holder and organizer of men's neckties. This embodiment is as in the accordion-folded, greeting card holder, wherein each panel between the creases is of a different color, representing a possible color of a men's shirt. The securing device, such as a plastic sheet protector, secures a plurality of men's neckties; the neckties color-coordinated with the panel color; the panel color representing a possible color of a men's shirt. This embodiment is envisaged as an aid for commercial color coordination, and for an aid for travelers to maintain men's neckties. Such an invention would fit in a suitcase or drawer, or hang in a closet.

### FIELD OF THE INVENTION

The present invention relates generally to the field of poster boards that can be held securely with handles.

### BACKGROUND OF THE INVENTION

Poster boards are well known in the field of the invention, and can be used for sporting event signage, notices, protests, congratulatory signs, banners and the like.

Large poster boards presently available, such as those used at sporting events, school projects, car washes, fund-raisers, etc. suffer from difficulty in storage, in maintenance, and in transport, as well as in display. Such boards tend to fold over or collapse in wind and rain, take up a great deal of space in vehicles, and can be unwieldy to use. Also, such presently available poster boards require artistic talent to keep lines and shapes straight and uniform.

It would be a vast improvement over presently available poster boards if such boards contained a handle device, and a combination of one or more of the following features. Among such features is the ability to fold or collapse the board, perhaps into an accordion form; to have pre-printed permanent lines such as gridlines described in U.S. Pat. No. 5,595,829 to Pitts et al., or erasable lines; to have pop-outs or cut-outs for visibility and safety in carrying; to have handles to aid in grasping and maintaining positioning of the board; to have pre-printed graphics or messages; to have fittings for attaching attention-getting devices such as flags or banners or lights or sound-producing means; and to have fittings for extending the board size.

Other possible improvements over presently available boards, would be if poster board systems could be used to display men's neckties in a fashion to allow color coordination with men's shirts; or if such systems could be used to display greeting cards.

### SUMMARY OF THE INVENTION

A series of embodiments of the poster board invention (“Smartboard™”) are presented, using various types of securing handles, to aid in grasping and maintaining positioning of the board.

Additional features of some of the embodiments of the poster board system with handles, include the ability to crease, fold, or collapse the board, such as into an accordion form; to have pre-printed permanent or erasable lines; to have pop-outs or cut-outs for visibility; to have pre-printed graphics or messages; to have fittings for attaching attention-getting devices such as flags, lights, sound-making devices, or banners; and to have fittings for extending the board size or for connecting multiple boards together.

The poster board system with handles allows the message to be more clearly seen, as there is less likelihood of the poster board folding over. Also, since the Smartboard™ is easier to hold than presently available poster boards, the user can show the project or message with more confidence.

The securing handles may be permanently and fixedly attached, or detachable. Among embodiments of the handles are securing means including adhesive foam, staples, or locking tab systems.

Another embodiment of the poster board system with handles is as a greeting card holder, in which securing devices are positioned between the creases of the accordion-folded poster board system. In this embodiment, the poster board system with handles, holds a plurality of greeting cards. Another embodiment of the poster board system with handles which holds greeting cards, includes a plastic sheet protector as the securing device.

A further embodiment of the poster board system with handles is as a holder and organizer of men's neckties. This embodiment is as in the accordion-folded, greeting card holder, wherein each panel between the creases is of a different color, representing a possible color of a men's shirt. The securing device, such as a plastic sheet protector, secures a plurality of men's neckties; the neckties color-coordinated with the panel color; the panel color representing a possible color of a men's shirt. This embodiment is envisaged as an aid for commercial color coordination, and for an aid for travelers to maintain men's neckties. Such an invention would fit in a suitcase or drawer, or hang in a closet.

These and other features of the present invention will be apparent to those of skill in the art, from a review of the following detailed description along with the accompanying drawings.

### BRIEF DESCRIPTION OF THE DRAWINGS

FIG. 1 represents a poster board with pre-printed permanent or erasable lines.

FIG. 2 displays a poster board with slidably detachable handles.

FIG. 3 shows an embodiment of the poster board system utilizing folds to produce an integral handle secured by sponge tape.

FIG. 4 depicts a collapsible poster board, foldable in an accordion style, for ease of packaging, storage, and use.

FIG. 5 exposes the storage problem of currently-available poster boards, such as in vehicles or lockers, or the inability to collapse such currently-available boards when not in use.

FIG. 6 diagrams an embodiment of the invention comprising folds and integral handles secured by sponge tape.

FIG. 7 is a representation of an embodiment of the invention comprising pop-out circles or sections, for increased visibility and safety.

FIG. 8 embodies an elongated folding poster board device suitable for banners.

FIG. 9 represents a system of sliding locks and accepting fittings attached to poster board systems, to allow the poster board systems to be extended, and for connecting multiple boards together—to form an elongated folding poster board device.

In FIG. 10, a further type of detachable handle is added to the poster board.

FIG. 11 contains a pictorial representation of a locking tab and socket system for securing integral handles to the poster board system.

FIG. 12 details the integral handle system formed by a first fold, a second fold, and a plurality of sponge tapes.

FIG. 13 displays greeting cards detachably affixed to the poster board system with plastic film or sheet protectors.

In FIG. 14, another greeting card usage of the poster board system, the board is foldable in an accordion-like style, and large pop-out figures allow the board to represent a large greeting card.

FIG. 15 represents detachable posts such that the portable poster board system can function as a self-supporting sign.

FIG. 16 depicts a portable poster board system for displaying men's neckties, with the neckties secured to color-coordinated panels.

### DETAILED DESCRIPTION OF PREFERRED EMBODIMENTS

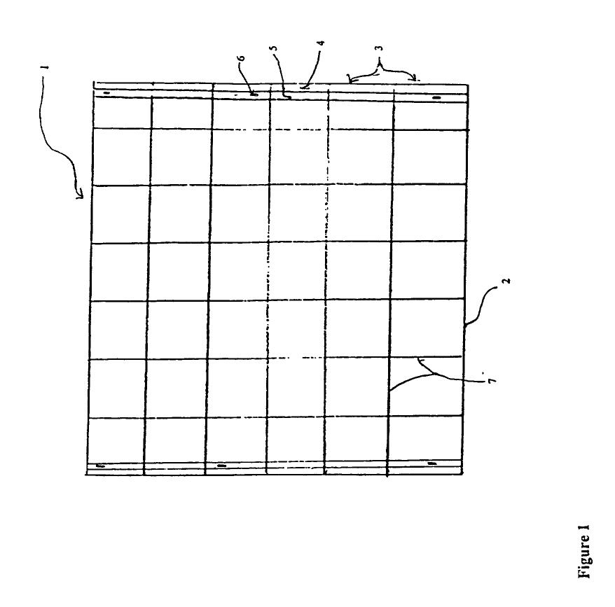

FIG. 1 represents a poster board with pre-printed permanent or erasable lines. A planar view is shown of a poster board system 1, with a poster board 2 having an integral handle system 3, comprising a first fold 4, a second fold 5; the first and second folds secured by a means for affixing 6 the folds of the integral handle system 3 to the poster board 2. Pre-printed permanent or erasable lines 7 are formed on the surface of the poster board 2.

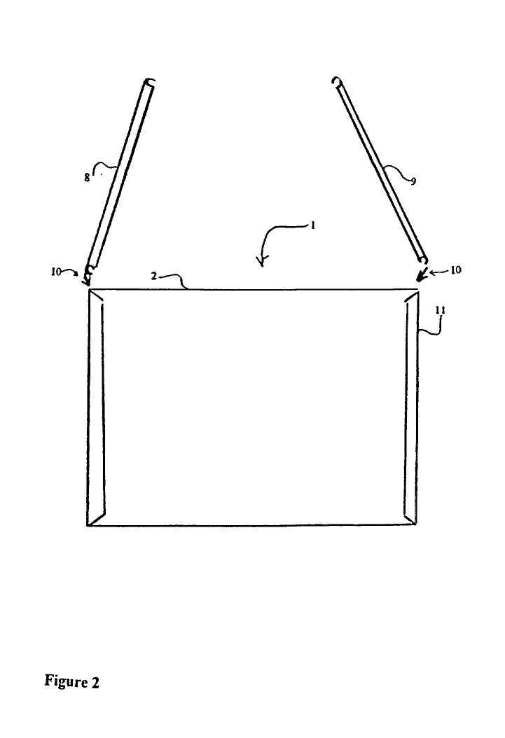

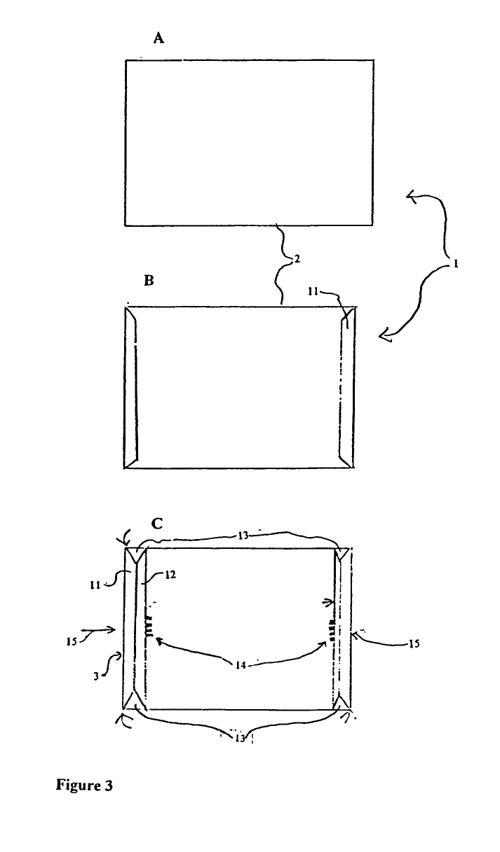

In FIG. 2, a poster board is displayed with slidably detachable handles. In a planar view, a poster board system 1, is displayed with a poster board 2 having a slidably detachable right handle 8 and left handle 9, the thick arrows 10 representing directions for sliding the handles on or off the poster board 2, the handles further secured to a first fold 11, integral with the poster board 2.

FIG. 3 shows an embodiment of the poster board system utilizing folds to produce an integral handle secured by sponge tape. In FIG. 3, are consecutive views A, B, and C showing one process of forming an integral handle for the poster board system 1. In FIG. 3A, the poster board 2 is depicted. In FIG. 3B, a first fold 11 is formed on either side of the poster board 2. In FIG. 3C, the first fold 11 is creased and folded to form a second fold 12, the folds held in place onto the poster board 2, using securing devices such as a plurality of sponge tapes 13, to complete the formation of the integral handle system 3, and allowing a place for positioning a finger hold 14, as part of a hand grip 15.

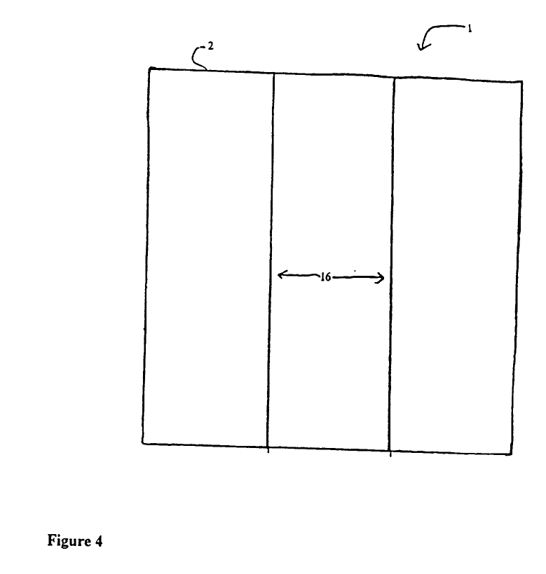

FIG. 4 depicts a collapsible poster board, foldable in an accordion style. For illustrative purposes, the poster board system 1 is displayed without handles. The poster board 2 is pre-creased 16 so that it can be folded in an accordion style (not shown in this figure), for ease of packaging, storage, and use.

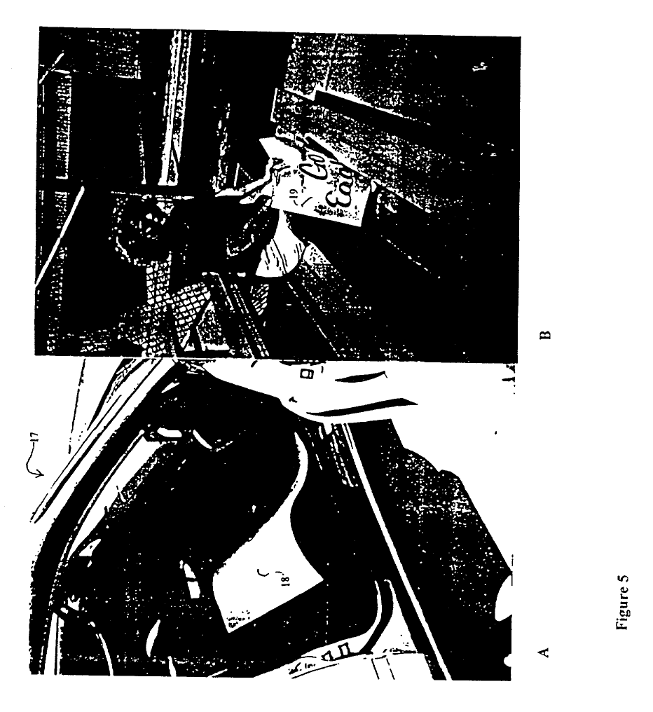

FIG. 5 exposes the storage problem of currently-available poster boards, such as in vehicles or lockers, or the inability to collapse such currently-available boards when not in use. FIG. 5A is a photograph of a vehicle 17, showing the difficulty of storing a poster board 18 which is not collapsible. In FIG. 5B, the non-collapsible poster board 19 is not in use, yet takes up unnecessary space.

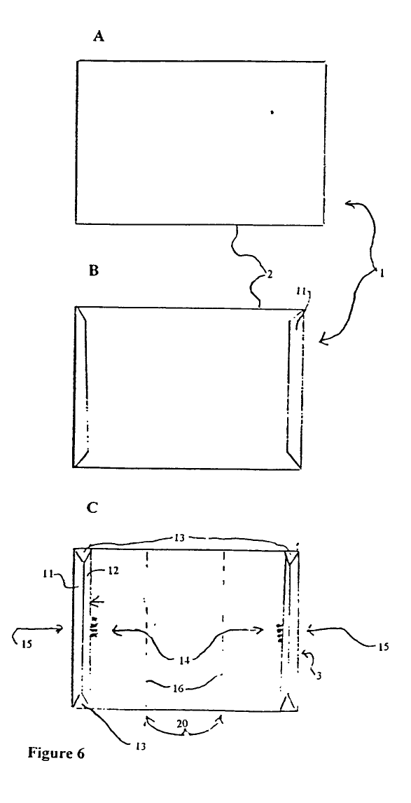

FIG. 6 diagrams an embodiment of the invention comprising folds and integral handles secured by sponge tape. Consecutive views A, B, and C show one process of forming an integral handle for the poster board system 1. In FIG. 6A, the poster board 2 is depicted. In FIG. 6B, a first fold 11 is formed on either side of the poster board 2. In FIG. 6C, the first fold 11 is creased and folded to form a second fold 12, the folds held in place onto the poster board 2, using securing devices such as a plurality of sponge tapes 13, to complete the formation of the integral handle system 3, and allowing a place for positioning a finger hold 14, as part of a hand grip 15. In this embodiment, the poster board 2, is pre-creased 16, allowing folds 20 to be made.

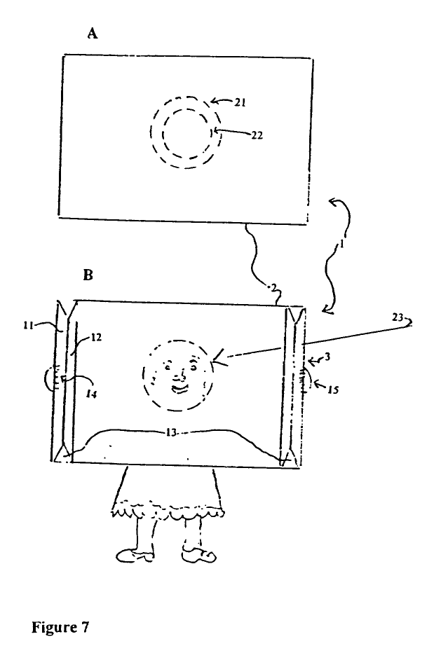

FIG. 7 is a representation of an embodiment of the invention comprising pop-out circles or sections, for increased visibility and safety. In FIG. 7A, the poster board system 1 comprises concentric cut-outs 21 and 22 which may be of any shape, but preferably in the shape of a circle as shown. In FIG. 7B, the cut-out 23 fits the outline of a face. Also shown in FIG. 7B is a poster board 2 with an integral handle system 3 having a first fold 11, which is creased and folded to form a second fold 12, the folds held in place onto the poster board 2, using securing devices such as a plurality of sponge tapes 13, to complete the formation of the integral handle system 3, allowing a place for positioning a finger hold 14, as part of a hand grip 15.

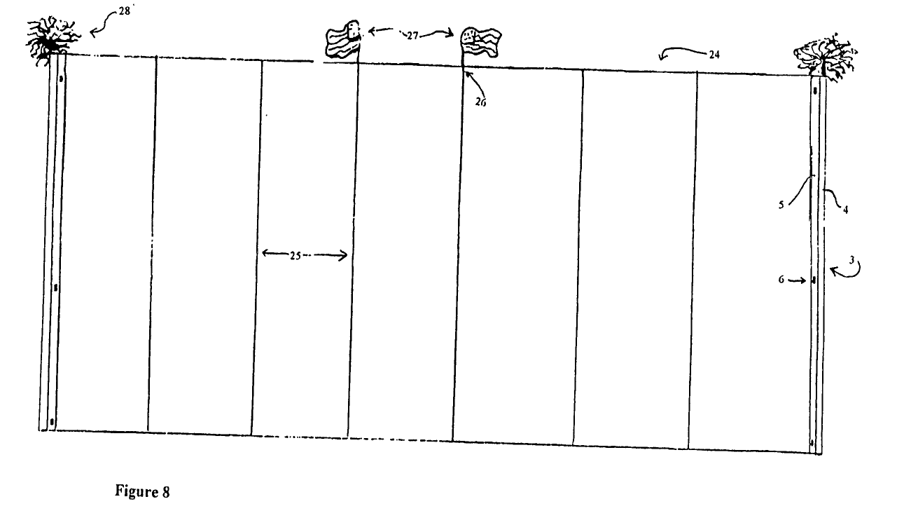

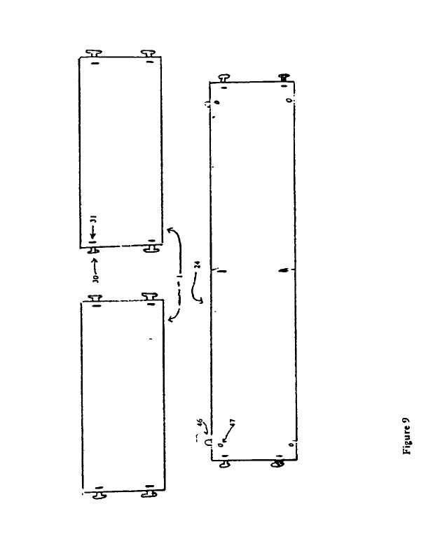

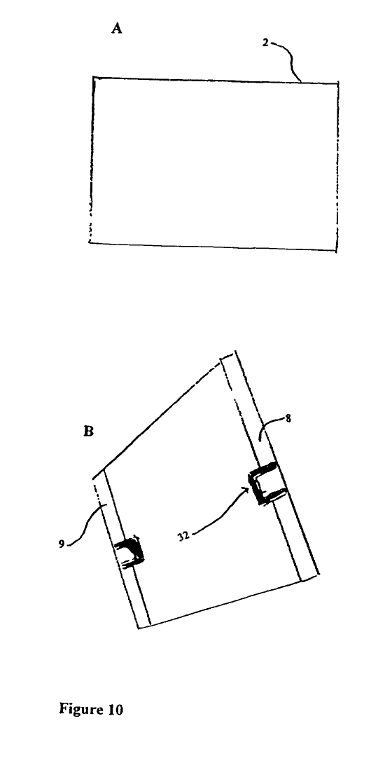

FIG. 8 embodies an elongated folding poster board device 24 suitable for banners. A plurality of folds 25 aids in handling and storage of the elongated folding poster board device 24. An integral handle system 3, comprising a first fold 4, a second fold 5; the first and second folds secured by a means for affixing 6 the folds of the integral handle system 3 to the elongated folding poster board device 24. Fittings 26 are provided for attaching attention-getting devices such as flags 27, lights (not shown), sound-making devices 28, or banners (not shown), to the elongated folding poster board device 24.

As depicted in FIG. 9, sliding locks 30 and accepting fittings 31 allow the poster board system 1 to be extended, for connecting multiple boards together; forming an elongated folding poster board device 24, by this second means. Also shown are hooks 46 and grommets 47 allowing the poster board (not shown) or elongated folding poster board device 24 to be wall mounted.

In FIG. 10, a further type of detachable handle is added to the poster board. In FIG. 10A, the poster board 2 is shown; in FIG. 10B, detachable handles 32 are depicted fixed attached to a slidably detachable right handle 8 and left handle 9.

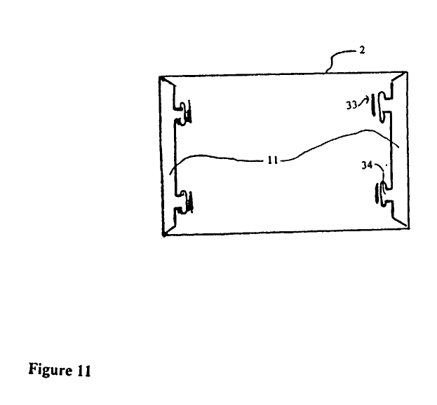

FIG. 11 contains a pictorial representation of a locking tab and socket system for securing integral handles to the poster board system. A first fold 11 is integral with the poster board 2. A plurality of sockets 33 is contained in the poster board 2, each socket 33 accepting a locking tab 34 fixedly attached to the first fold 11 (or to a second fold—not shown).

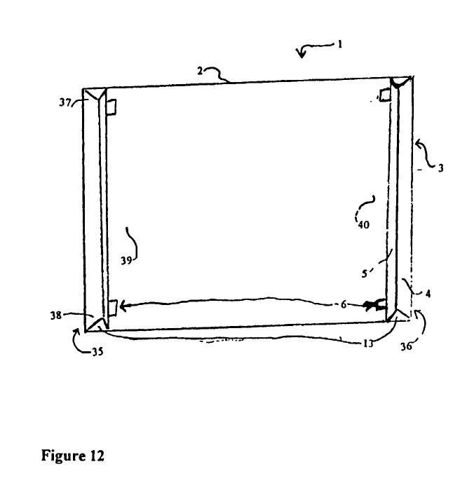

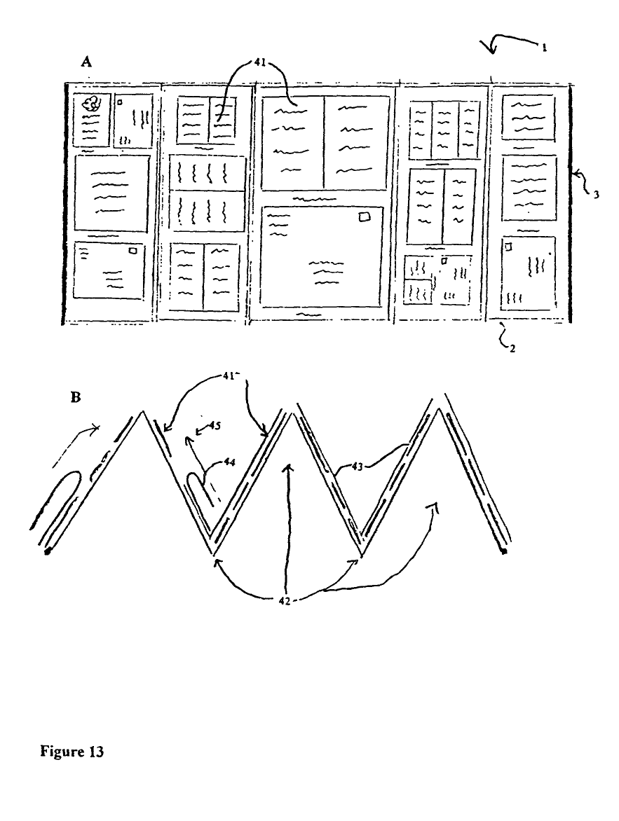

FIG. 12 details the integral handle system formed by a first fold, a second fold, and a plurality of sponge tapes. The portable poster board system 1, with a poster board 2 having an integral handle system 3, comprising a first fold 4, a second fold 5; the first and second folds secured by a means for affixing 6 (such as a plurality of sponge tapes 13) the folds of the integral handle system 3 to the poster board 2. The first fold 4 and second fold 5 are formed from a first lateral end portion 35 or from a second lateral end portion 36 of the poster board 2; the first lateral end portion 35 or second lateral end portion 36 having a top corner 37 and a bottom corner 38. The first fold 4 and second fold 5 connecting the first lateral end portion 35 to a first lateral section 39 of the poster board 2; the second lateral end portion 36 secured to a second lateral section 40 of the poster board 2. Typically, lateral end portions 35, 36 are secured to lateral sections 39, 40 with sponge tapes 13 secured to the top 37 or bottom 38 corners of the lateral end portions 35, 36. The sponge tapes 13 typically further comprise pieces of sponge-like material (not shown) and adhesive fixedly applied (not shown) to the sponge-like material, the sponge tapes 13 detachably affixing a lateral end portion 35, 36 to a lateral section 39, 40 of the poster board 2.

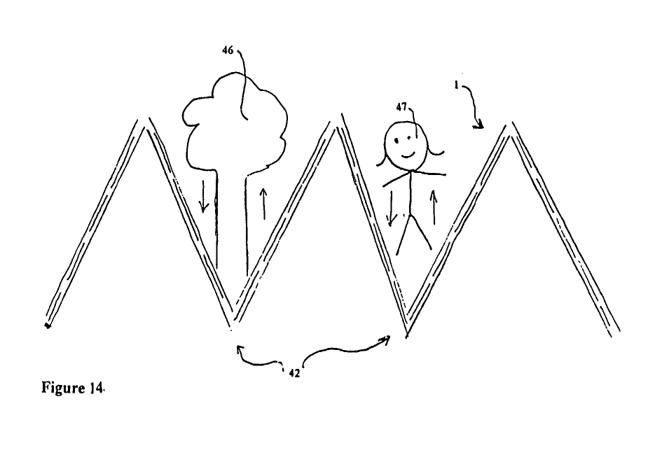

FIG. 13 is a planar view showing greeting cards detachably affixed to the poster board system with plastic film or sheet protectors. In FIG. 13A, greeting cards 41 are detachably affixed to the poster board 2 of the poster board system 1, having an integral handle system 3. In FIG. 13B in end view, the poster board 2, is foldable in an accordion-like fashion 42. The greeting cards 41 are held in place with transparent, plastic sheet protectors 43 or plastic film 44 shown unfolding in the direction of the arrow 45.

In FIG. 14, an end view depicting another greeting card usage of the poster board system, the poster board system 1 is foldable in an accordion-like fashion 42, and large pop-out figures 46, 47 allow the board to represent a large greeting card.

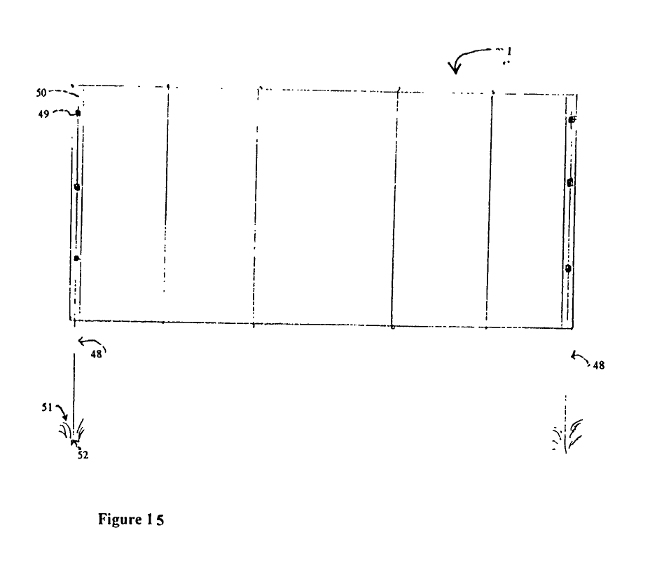

In FIG. 15, elongated posts 48 are detachably affixed at a first end 49 to a handle 50 of the portable poster board system 1, the posts 48 inserted at a second end 51 into a support medium 52, such as earth, such that the portable poster board system functions as a self-supported sign.

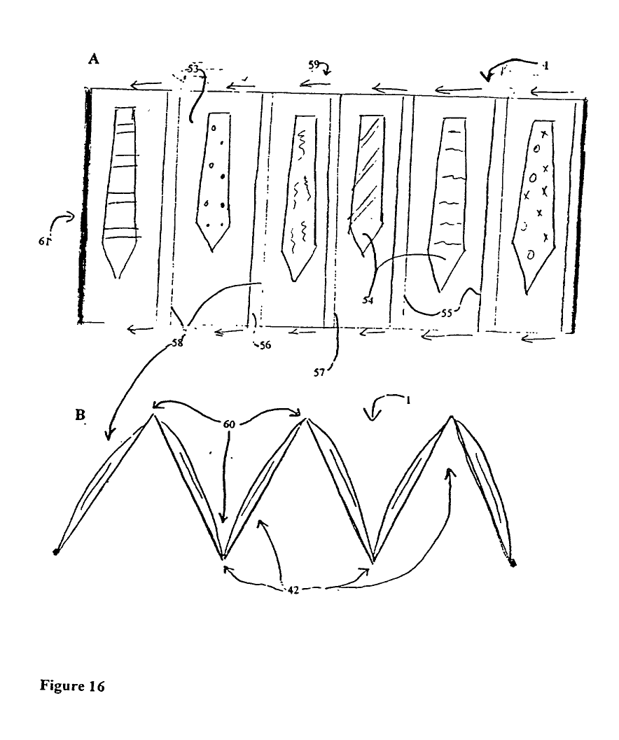

In FIG. 16, depicted is a portable poster board system for displaying men's neckties. FIG. 16A shows a poster board system 1 comprised of panels 53 in a plurality of colors representing colors of men's shirts. Men's neckties 54 are secured to each panel 53, the neckties 54 color-coordinated with the panels 53. In the present embodiment, the neckties 54 are secured to the panels 53 with sheet protectors 55. A slot 56 is located at each fold 57 of the poster board system 1, allowing the neckties 54 to be added to the resulting compartments 58, in the direction of the displayed arrows 59. In FIG. 16B, an end view of the poster board system 1 shows a series of creases 60 allowing the poster board system to be folded in an accordion-like fashion 42, when the compartments 58 do not need to be displayed; the folding being aided by the presence of integral or detachable handles 61.

The principles, preferred embodiments, and modes of operation of the present invention have been described in the foregoing specification. This invention is not to be construed as limited to the particular forms disclosed, since these are regarded as illustrative rather than restrictive. Moreover, variations and changes may be made by those skilled in the art, without departing from the spirit of the invention.

I claim:

1. A portable poster board system comprising:
a poster board; and
a handle system affixed to said poster board.

2. The portable poster board system of claim 1, wherein the handle system is integral and permanently affixed to the poster board.

3. The portable poster board system of claim 1, wherein the handle system is detachably affixed to the poster board.

4. The portable poster board system of claim 1, the handle system further comprising:
a first lateral end portion of the poster board having a top corner and a bottom corner;
a fold connecting the first lateral end portion to a first lateral section of the poster board;
means for attachment adhered to the top and bottom corners of the first lateral end portion; the means for attachment affixing the first lateral end portion to the first lateral section of the poster board;
a second lateral end portion of the poster board having a top corner and a bottom corner;
a fold connecting the second lateral end portion to a second lateral section of the poster board; and
means for attachment adhered to the top and bottom corners of the second lateral end portion; the means for attachment affixing the second lateral end portion to the second lateral section of the poster board.

5. The portable poster board system of claim 1, the handle system further comprising:
a first lateral end portion of the poster board having a top corner and a bottom corner;
a fold connecting the first lateral end portion to a first lateral section of the poster board;
sponge tapes for securing portions of the poster board system, the sponge tapes further comprising:
pieces of sponge-like material; and
adhesive fixedly applied to the sponge-like material;
a plurality of the sponge tapes adhered to the top and bottom corners of the first lateral end portion; the sponge tapes detachably affixing the first lateral end portion to the first lateral section of the poster board;
a second lateral end portion of the poster board having a top corner and a bottom corner;
a fold connecting the second lateral end portion to a second lateral section of the poster board; and
a plurality of the sponge tapes adhered to the top and bottom corners of the second lateral end portion; the sponge tapes detachably affixing the second lateral end portion to the second lateral section of the poster board.

6. The portable poster board system of claim 1, the handle system further comprising:
a first lateral end portion of the poster board having a top corner and a bottom corner;
a fold connecting the first lateral end portion to a first lateral section of the poster board;
a plurality of tabs extending from the top and bottom corners of the first lateral end portion;
a plurality of sockets contained in the first lateral section of the poster board, a socket accepting a tab extending from a corner of the first lateral end portion; a plurality of tabs and accepting sockets interlocking to detachably affix the first lateral end portion to the first lateral section of the poster board;
a second lateral end portion of the poster board having a top corner and a bottom corner;
a fold connecting the second lateral end portion to a second lateral section of the poster board;
a plurality of tabs extending from the top and bottom corners of the second lateral end portion; and
a plurality of sockets contained in the second lateral section of the poster board, a socket accepting a tab extending from a corner of the second lateral end portion; a plurality of tabs and accepting sockets interlocking to detachably affix the second lateral end portion to the second lateral section of the poster board.

7. The portable poster board system of claim 1, wherein elongated posts are detachably affixed at a first end to a handle, the posts inserted at a second end into a support medium, such that the portable poster board system functions as a self-supported sign.

8. The portable poster board system of claim 1, wherein fittings are attached to the poster board; the fittings accepting devices selected from the group consisting of flags, banners, lights, and sound-producing devices.

9. The portable poster board system of claim 1, wherein a plurality of fittings is attached to a lateral end portion of the poster board; the fittings extending the poster board; the fittings accepting a plurality of lateral end portions of additional poster boards.

10. The portable poster board system of claim 1, wherein the poster board system is collapsible.

11. The portable poster board system of claim 1, wherein the poster board system is foldable in an accordion-like fashion.

12. The portable poster board system of claim 1 further comprising pop-out portions.

13. The portable poster board system of claim 1 further comprising pre-printed permanent lines and graphics.

14. The portable poster board system of claim 1 further comprising pre-printed erasable lines and graphics.

15. The portable poster board system of claim 1 further comprising fixedly attached pop-out sections, the pop-out sections visible when the poster board system is opened in the fashion of a large greeting card.

16. The portable poster board system of claim 1 further comprising a flash card system usable at sporting events, the flash card system opening and closing during short periods of time.

17. The portable poster board system of claim 1, the poster board being of a translucent material.

18. The portable poster board system of claim 1, the handles being slidably and detachably connected to lateral end portions of the poster board.

19. The portable poster board system of claim 1, wherein the handles comprise elongated strips slidably attached to lateral end portions of the poster board.

20. The portable poster board system of claim 1, wherein the handles are wall-mountable.

21. The portable poster board system of claim 1, wherein the poster board is manufactured with pre-formed creases to aid in folding.

22. A portable poster board system for displaying greeting cards, the poster board system having creases and folds in an accordion-like fashion, further comprising:
a poster board;
a handle system affixed to said poster board;
a plurality of securing devices positioned between the creases of the accordion-folded poster board system; and
a plurality of greeting cards secured to the portable poster board system with the securing devices.

23. The portable poster board system of claim 22, wherein the securing devices for the greeting cards are plastic sheet protectors; the plastic sheet protectors fixedly attached to a surface of the poster board system.

24. A portable poster board system for displaying men's neckties, the poster board system having creases and folds in an accordion-like fashion, further comprising:
a poster board;
a handle system affixed to said poster board;
a plurality of securing devices positioned between the creases of the accordion-folded poster board system;
a plurality of men's neckties secured to the portable poster board system with the securing devices.

25. The portable poster board system of claim 24, wherein the securing devices are plastic sheet protectors; the plastic sheet protectors fixedly attached to a surface of the poster board system; the plastic sheet protectors securing the men's neckties to the portable poster board system.

26. The portable poster board system of claim 24, wherein panels located between the folds are in a plurality of colors; the panels representing colors of men's shirts; the colored panels aiding color-coordination between the men's shirts and the men's neckties.
